(19) United States
(12) Patent Application Publication
(10) Pub. No.: US 2018/0043536 A1
(43) Pub. Date: Feb. 15, 2018

(54) INTELLIGENT MOTION CONTROL SYSTEM AND METHOD

(71) Applicant: HON HAI PRECISION INDUSTRY CO., LTD., New Taipei (TW)

(72) Inventors: YOU-YUN LEE, New Taipei (TW); KUANG-YU LIU, New Taipei (TW); YA-KUAN CHUANG, New Taipei (TW); PO-HSIANG CHEN, New Taipei (TW); PO-CHENG CHEN, New Taipei (TW)

(21) Appl. No.: 15/253,723

(22) Filed: Aug. 31, 2016

(30) Foreign Application Priority Data
Aug. 10, 2016 (CN) 201610650548.X

(51) Int. Cl. B25J 9/16; G05D 1/02

(52) U.S. Cl. CPC B25J 9/1682; B25J 9/1651; B25J 9/1666; B25J 9/163; G05D 1/0212; G05D 1/0274; G05D 1/0214; Y10S 901/08; Y10S 901/01; G05B 2219/39082; G05B 2219/39091; G05B 2219/40475; G05B 2219/40476

(57) ABSTRACT

An intelligent motion control system for devices moving in a locality includes a number of intelligent motion bodies and a server. The server includes a storage module, a task assigning module, a path planning module, and a communication module. The storage module stores a map and a path planning rule. The task assigning module assigns a motion task to each intelligent motion body. The path planning module plans a moving path for each intelligent motion body according to the map, the motion task, and the path planning rule. The communication module transmits the moving path to the intelligent motion body. The intelligent motion body moves according to the moving path and can provide feedback to the server as to any obstacles in the moving path. An intelligent motion control method is also disclosed.

### CROSS-REFERENCE TO RELATED APPLICATIONS

This application claims priority to Chinese Patent Application No. 201610650548.X, filed on Aug. 10, 2016, the contents of which are incorporated by reference herein.

### FIELD

The subject matter herein generally relates to intelligent motion control system and method.

### BACKGROUND

Moving Paths for intelligent motion bodies (for example, robot) are planned for each intelligent motion body. When a locality where the intelligent motion body moves is changed, the moving path should be updated in the body.

### BRIEF DESCRIPTION OF THE DRAWINGS

Implementations of the present technology will now be described, by way of example only, with reference to the attached figures.

FIG. 1 is a schematic view of an intelligent motion control system.

FIG. 2 is a block diagram of the intelligent motion control system in FIG. 1.

FIG. 3 is a flowchart of an intelligent motion control method according to an embodiment.

FIG. 4 is a flowchart of an intelligent motion control method according to another embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series, and the like.

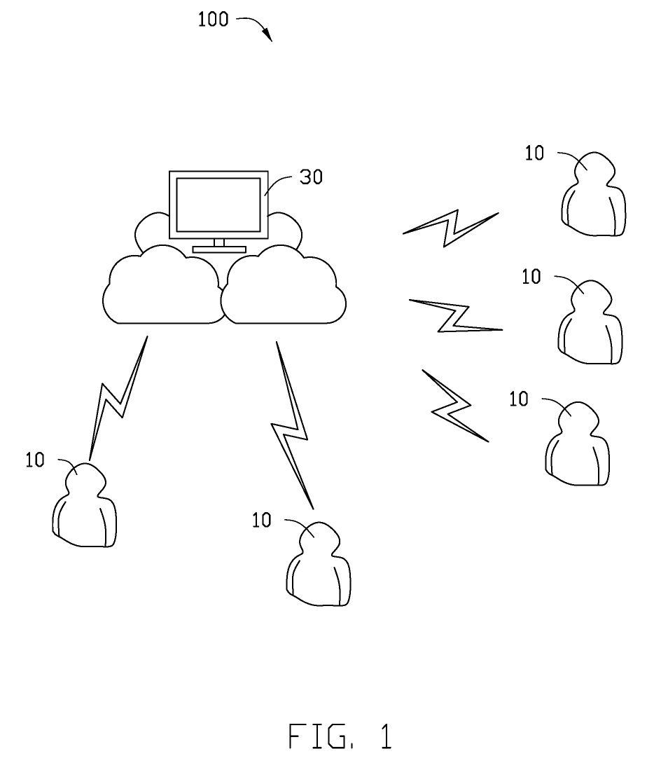

The instant disclosure provides an intelligent motion control system 100. FIG. 1 illustrates the intelligent motion control system 100 including a number of intelligent motion bodies 10 and a server 30. The server 30 communicates with the intelligent motion bodies 10. The server 30 is configured to control the intelligent motion body 10 to move. The intelligent motion body 10 can be a robot.

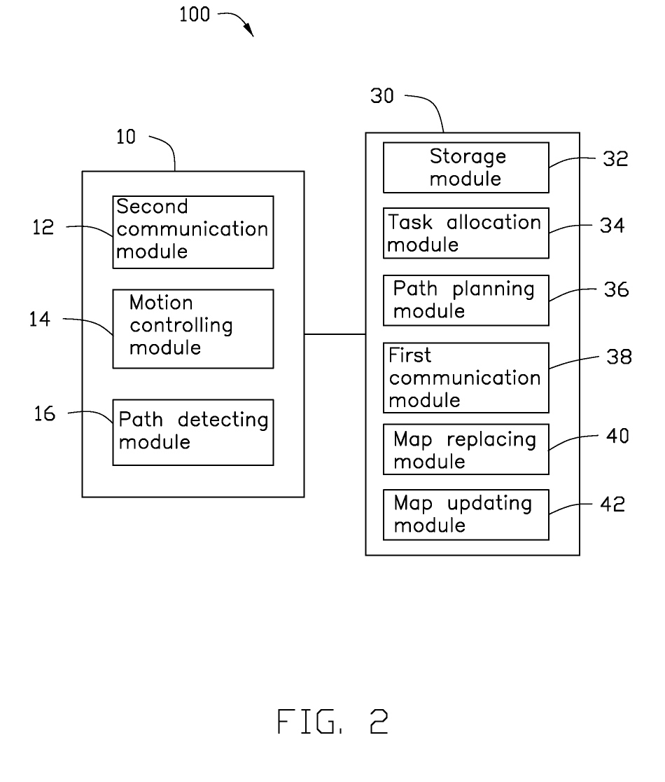

FIG. 2 illustrates the server 30 as including a storage module 32, a task allocation module 34, a path planning module 36, and a first communication module 38. The storage module 32 stores a map of a locality where the intelligent motion body is located. The storage module 32 further stores a path planning rule. The task assigning module 34 is configured to assign a movement or series of movements (motion task) to each intelligent motion body 10. The motion task includes a motion start point and a motion end point. In another embodiment, the motion task further includes a moving start time and a moving end time. The path planning module 36 is configured to plan a moving path for each intelligent motion body 10 according to the map, the task assigned to the intelligent motion body 10, and the path planning rule. The moving path includes a moving direction, a moving distance in each moving direction, a moving speed in each moving direction, and an order of the moving directions. In an embodiment, the path planning rule is that none of the intelligent motion bodies 10 should collide with each other. In another embodiment, the path planning rule is that the intelligent motion body 10 completes the task in the shortest moving path or the shortest time. The first communication module 38 is configured to transmit the moving path to an intelligent motion body 10.

The server 30 includes a map replacing module 40. The map updating module 40 is configured to replace the existing map with a new map. Thus, the path planning module 36 plans the moving path according to the new map.

The intelligent motion body 10 includes a second communication module 12 and a motion controlling module 14. The second communication module 12 is configured to receive the moving path from the server 30. The motion controlling module 14 is configured to control the intelligent motion body 10 to move according to the moving path.

The intelligent motion body 10 further includes a path detecting module 16. The path detecting module 16 is configured to detect whether there is an obstacle in the moving path and if so a position of the obstacle. In detail, the path detecting module 16 in real time detects whether there is an obstacle at the present direction and within a certain distance before changing direction. The second communication module 12 is further configured to transmit the position of the obstacle to the server 30.

The server 30 further includes a map updating module 42. The map updating module 42 is configured to update the map according to the position of the obstacle. The path planning module 36 is further configured to re-plan the moving path according to the updated map. The first communication module 38 is further configured to transmit the re-planned moving path to the relevant intelligent motion body 10. The motion controlling module 14 controls the intelligent motion body 10 to move according to the re-planned moving path. When there is an obstacle, the path detecting module 16 further identifies the nature of the obstacle. For example, the path detecting module 16 may identify an obstacle as being a flowerpot. The map updating module 42 is further configured to label a marker corresponding to the obstacle at the corresponding position in the updated map.

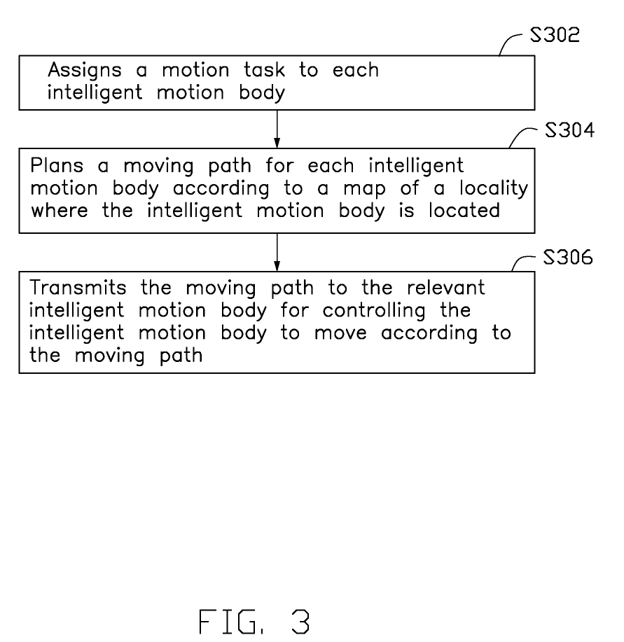

FIG. 3 illustrates an intelligent motion control method according to an embodiment. The order of blocks in FIG. 3 illustrative only and the order of the blocks can change. Additional blocks can be added or fewer blocks may be utilized without departing from this disclosure. The exemplary method begins at block 302.

At block 302, the task assigning module 34 assigns a motion task to each intelligent motion body 10, wherein the motion task includes a motion start point and a motion end point.

At block 304, the path planning module 36 plans a moving path for each intelligent motion body 10 according to a map of a locality where the intelligent motion body is located. The motion task assigned to the intelligent motion body 10 is planned according to a path planning rule, wherein the moving path includes a moving direction, a moving distance in each moving direction, and a moving speed in the moving direction. In another embodiment, the moving path includes a number of moving directions and an order of the moving directions.

In an embodiment, the path planning rule requires that none of the intelligent motion bodies 10 should collide with each other. In another embodiment, the path planning rule is that the intelligent motion body 10 completes the task in the shortest moving path.

At block 306, the first communication module 38 transmits the moving path to the relevant intelligent motion body 10 for controlling the intelligent motion body 10 to move according to the moving path.

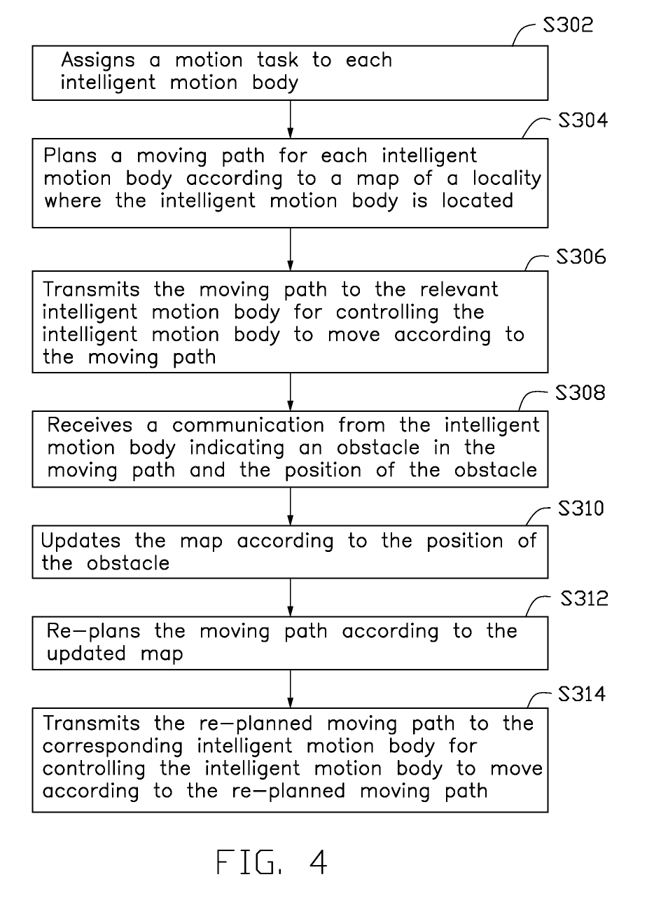

FIG. 4 illustrates an intelligent motion control method according to another embodiment. The intelligent motion control method further includes following blocks.

At block 308, the first communication module 38 receives a communication from the intelligent motion body 10 indicating an obstacle in the moving path and the position of the obstacle.

At block 310, the map updating module 42 updates the map to include the position of the obstacle.

At block 312, the path planning module 36 re-plans the moving path according to the updated map.

At block 314, the first communication module 38 transmits the re-planned moving path to the relevant intelligent motion body 10 for controlling the intelligent motion body 10 to move according to the re-planned moving path.

The embodiments shown and described above are only examples. Even though numerous characteristics and advantages of the present technology have been set forth in the foregoing description, together with details of the structure and function of the present disclosure, the disclosure is illustrative only, and changes may be made in the detail, comprising in matters of shape, size, and arrangement of the parts within the principles of the present disclosure, up to the full extent established by the broad general meaning of the terms used in the claims.

What is claimed is:

1. An intelligent motion control system comprising:
a plurality of intelligent motion bodies, each intelligent motion body comprising a motion controlling module; and
a server communicating with each intelligent motion body, the server comprising:
a storage module storing a map of a locality where the intelligent motion body is located and a path planning rule;
a task assigning module configured to assign motion task to each intelligent motion body, the motion task comprising a motion start point and a motion end point;
a path planning module configured to plan a moving path for each intelligent motion body according to the map, the motion task assigned to the intelligent motion body and the path planning rule;
a first communication module configured to transmit the moving path to the corresponding intelligent motion body; and
wherein the motion controlling module controls the intelligent motion body to move according to the moving path.

2. The intelligent motion control system as claimed in claim 1, wherein the moving path comprises a number of moving directions, moving distances in each moving direction and an order of the moving directions.

3. The intelligent motion control system as claimed in claim 2, wherein the moving path further comprises moving speeds in each moving direction.

4. The intelligent motion control system as claimed in claim 1, wherein the path planning rule is none of the intelligent motion bodies should collide with each other.

5. The intelligent motion control system as claimed in claim 1, wherein the path planning rule is that the intelligent motion body completes the task in the shortest moving path.

6. The intelligent motion control system as claimed in claim 1, wherein the intelligent motion body further comprises a path detecting module, the path detecting module is configured to detect whether there is an obstacle in the moving path and if so a position of the obstacle, the intelligent motion body transmits the position of the obstacle to the server.

7. The intelligent motion control system as claimed in claim 6, wherein the path detecting module in real time detects whether there is an obstacle during the moving path.

8. The firmware updating system as claimed in claim 6, wherein the server further comprises a map updating module, the map updating module is configured to update the map according to the position of the obstacle.

9. The intelligent motion control system as claimed in claim 8, wherein the path planning module is further configured to re-plan the moving path according to the updated map, the first communication module is further configured to transmit the re-planned moving path to the corresponding intelligent motion body, the motion controlling module controls the intelligent motion body to move according to the re-planned moving path.

10. The intelligent motion control system as claimed in claim 8, wherein the path detecting module further identifies the nature of the obstacle.

11. The intelligent motion control system as claimed in claim 10, wherein the map updating module is further configured to label a mark corresponding to the obstacle at the corresponding position in the updated map.

12. The intelligent motion control system as claimed in claim 1, the intelligent motion body is a robot.

13. An intelligent motion control method employed in a server communicating with a number of intelligent motion bodies comprising:
assigning motion task to each intelligent motion body, wherein the motion task comprises a motion start point and a motion end point;
planning a moving path for each intelligent motion body according to a map of a locality where the intelligent motion body is located, motion task assigned to the intelligent motion body and a path planning rule; and
transmitting the moving path to the corresponding intelligent motion body for controlling the intelligent motion body to move according to the moving path.

14. The intelligent motion control method as claimed in claim 13, further comprising:
receiving a position of an obstacle in the moving path transmitted from the intelligent motion body; and
updating the map according to the position of the obstacle.

15. The intelligent motion control method as claimed in claim 14, further comprising:
re-planning the moving path according to the updated map; and
transmitting the re-planned moving path to the corresponding intelligent motion body for controlling the intelligent motion body to move according to the re-planned moving path.

16. The intelligent motion control method as claimed in claim 13, wherein the moving path comprises a number of moving directions, moving distances in each moving direction and an order of the moving directions.

17. The intelligent motion control method as claimed in claim 16, wherein the moving path further comprises moving speeds in each moving direction.

18. The intelligent motion control method as claimed in claim 13, wherein the path planning rule is that none of the intelligent motion bodies should collide with each other.

19. The intelligent motion control method as claimed in claim 13, wherein the path planning rule is that the intelligent motion body completes the task in the shortest moving path.

20. The intelligent motion control method as claimed in claim 13, wherein the intelligent motion body is a robot.
